(19) United States
(12) Patent Application Publication
(10) Pub. No.: US 2017/0011649 A1
(43) Pub. Date: Jan. 12, 2017

(54) RECIPE SYSTEM

(71) Applicant: Samsung Electronics Co., Ltd., Suwon-si (KR)

(72) Inventors: Chunkwok LEE, Santa Clara, CA (US); Shweta GRAMPUROHIT, Sunnyvale, CA (US)

(21) Appl. No.: 14/880,717

(22) Filed: Oct. 12, 2015

Related U.S. Application Data
(60) Provisional application No. 62/191,256, filed on Jul. 10, 2015.

(51) Int. Cl. G09B 19/00; G09B 5/02

(52) U.S. Cl. CPC G09B 19/00; G09B 5/02

(57) ABSTRACT

In one aspect, a method for guiding one or more users through steps of a recipe is described. A recipe is obtained. One or more users are identified. A cooking proficiency of each of the users is determined. A sequence of cooking steps is determined based on the recipe and the cooking proficiency of the users. The sequence is transmitted to one or more appliances. Various implementations involve appliances, devices, systems and software that relate to the above method.

### CROSS-REFERENCE TO RELATED APPLICATIONS

This application claims the priority of U.S. Provisional Patent Application No. 62/191,256, entitled “Smart Recipe System for Appliances Coordination and Control,” filed Jul. 10, 2015, which is incorporated by reference in its entirety for all purposes.

### FIELD OF THE INVENTION

The present invention relates to a method and system for guiding a user through one or more cooking steps.

### BACKGROUND

Cooking is often enjoyable but also quite challenging in many respects. For one, it is difficult to prepare the same dish multiple times at the same level of quality. This is in part because the tools used to cook foods (e.g., an oven, a gas burner, etc.) are not highly precise and do not provide feedback regarding the cooking process. Veteran cooks use intuition and experience to guide them through the cooking process, but cooks with less experience often have difficulty knowing when a step in a recipe has been performed correctly.

Also, cooks are sometimes required to prepare multiple dishes at once. Each dish can require multiple steps, and coordinating these steps can be a difficult. This is particularly true if the cook wishes to complete the dishes as quickly and efficiently as possible.

Lastly, many recipes can be quite intimidating for beginning cooks. A recipe may require multiple steps using multiple appliances. Many cooks would appreciate additional guidance on how to cook such complicated dishes.

### SUMMARY

In one aspect, a method for guiding one or more users through steps of a recipe is described. A recipe is obtained. One or more users are identified. A cooking proficiency of each of the users is determined. A sequence of cooking steps is determined based on the recipe and the cooking proficiency of the users. The sequence is transmitted to one or more appliances. Various implementations involve appliances, devices, systems and software that relate to the above method.

### BRIEF DESCRIPTION OF THE DRAWINGS

The invention and the advantages thereof, may best be understood by reference to the following description taken in conjunction with the accompanying drawings in which:

FIG. 1 is a block diagram of a cooking guidance system according to a particular embodiment of the present invention.

FIGS. 2A-2B are flow diagrams illustrating a method for guiding one or more users through a recipe according to a particular embodiment of the present invention.

FIG. 3 is a block diagram illustrating cooking steps according to a particular embodiment of the present invention.

FIG. 4 is a block diagram of a cooking step data frame according to a particular embodiment of the present invention.

FIG. 5 is block diagram of cooking steps associated with a user and appliances according to various embodiments of the present invention.

FIG. 6 is a block diagram of cooking steps and associated dependencies according to a particular embodiment of the present invention.

FIG. 7 is a block diagram of a sequence of cooking steps according to a particular embodiment of the present invention.

FIG. 8 is a block diagram of an adjusted sequence of cooking steps according to a particular embodiment of the present invention.

FIG. 9 is a block diagram of a coordinating device according to a particular embodiment of the present invention.

FIG. 10 is a block diagram of an appliance according to a particular embodiment of the present invention.

FIG. 11 is a flow diagram illustrating a method for generating a sequence of cooking steps according to a particular embodiment of the present invention.

In the drawings, like reference numerals are sometimes used to designate like structural elements. It should also be appreciated that the depictions in the figures are diagrammatic and not to scale.

### DETAILED DESCRIPTION

As noted in the Background, cooking particular dishes can require multiple steps and appliances, and thus can require considerable coordination and skill. Such dishes can be particularly difficult for cooks with limited experience. To address this issue, various embodiments are described herein that relate to a system for guiding one or more users through a cooking process.

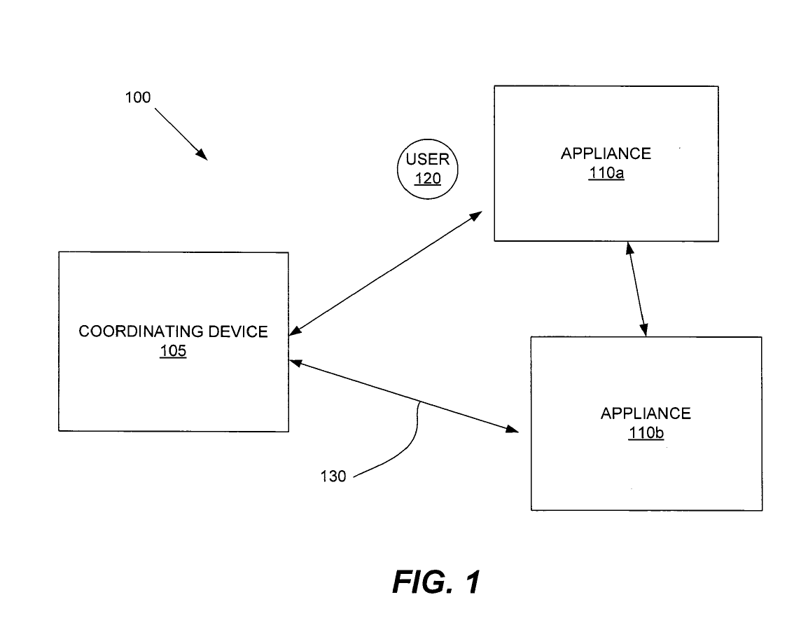

Referring initially to FIG. 1, a cooking guidance system 100 according to a particular embodiment of the present invention will be described. The system 100 includes a coordinating device 105, an appliance 110a, an appliance 110b and a user 120. The coordinating device 105 and the appliances 110a/110b are capable of communicating with one another through a network 130. In some implementations, there may be more users. Additionally, there may be more or fewer appliances and/or coordinating devices.

The coordinating device 105 is arranged to help the users complete a recipe. In some implementations, the coordinating device is another appliance (e.g., a refrigerator), but may also be any suitable device (e.g., a dedicated cooking guidance device, a laptop, a computer, a smart phone, a tablet, a smart watch, etc.) The device 105 coordinates the performance of different tasks by different users at the various appliances.

In the illustrated embodiment, the coordinating device 105 obtains one or more recipes e.g., a recipe to cook lasagna. The recipe is broken down into multiple cooking steps. The coordinating device 105 associates each step with a particular user 120 and/or appliance 110a/110b. For example, if the recipe involves cooking lasagna, one step may involve the user 120 boiling water at appliance 110a, which in this example is an oven with a gas range. Another step may involve the user grating cheese at appliance 110b, which is a food processor with a grater. If there are multiple users, the coordinating device 105 may assign different steps to different users.

In various implementations, the coordinating device 105 determines a sequence of cooking steps that makes optimal use of the available users and appliances. In generating the sequence, the device 105 may also take into account the skills and cooking proficiency of each of the users. Some embodiments involve accessing a stored profile on each user, which may indicate, for example, how much general cooking experience the user has and/or whether the user has cooked the same or similar dishes in the past. If a user has less experience, the coordinating device 105 may estimate that a particular cooking step will take a longer period of time for that user to complete. The device 105 takes this time into account when determining the sequence of cooking steps.

In many cases, it is more efficient for cooking steps to be performed in parallel. For example, for a lasagna recipe, while user 120 boils water to cook the noodles, the user 120 can grate the cheese and/or prepare the tomato sauce. It can be complicated and difficult for an inexperienced cook to determine such parallel steps, particularly when multiple dishes are being prepared or multiple users are involved. In various embodiments, the coordinating device 105 automates this process and allows the cooks to focus on food preparation rather than the scheduling and timing of cooking steps.

The coordinating device 105 then transmits data relating to the sequence of each cooking step to the appliances 110a/110b. The appliances 110a/110b may be any suitable kitchen- or cooking-related appliance. In some embodiments, each appliance may be but is not limited to a scale, a food processor, an oven, a microwave oven, a gas or electric range, a refrigerator, a coffee maker or any other suitable device.

In this example, the appliance 110b is a food processor and the appliance 110a is a gas range. Thus, the device 105 transmits data relating to the grating step to appliance 110b and data relating to the boiling step to appliance 110a. In various implementations, the transmitted data indicates instructions to the associated appliance, an estimated completion time for the step and/or data used by the appliance to help guide the user through the step (e.g., an instructional video guide, audio comments, etc.). The data for each step also indicates the order or timing of the step relative to the other steps.

Each appliance 110a/110b receives the cooking step data transmitted from the coordinating device 105. Based on the data, the appliances guide the user through the cooking steps in the predetermined order and monitors the implementation of the steps. For example, initially, the appliance 110a (e.g., the gas range) may display a message, indicating that the user should press a button. Upon the pressing of the button, the appliance automatically ignites a burner, sets the burner to generate a desired amount of heat and displays a message instructing the user to place a pot of water on the burner. The gas range includes sensors that monitor the boiling of the water. When it is determined that the boiling is complete, the system guides the user to the next step and appliance, as appropriate. In various implementations, the appliances send feedback to the coordinating device, indicating the progress the user has made in completing each cooking step.

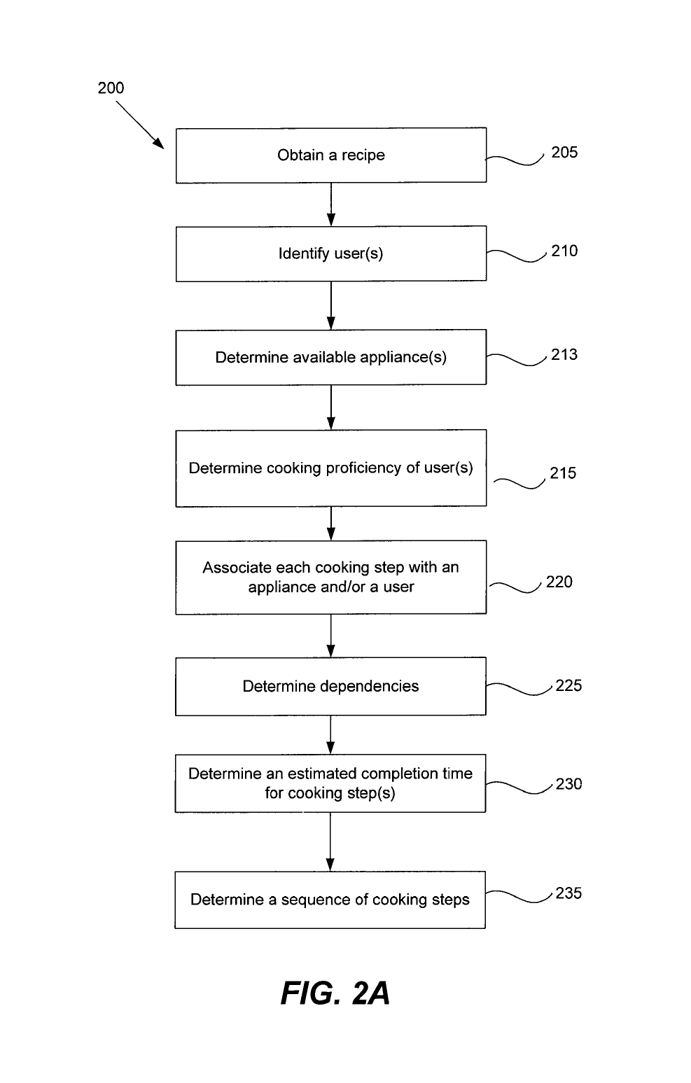

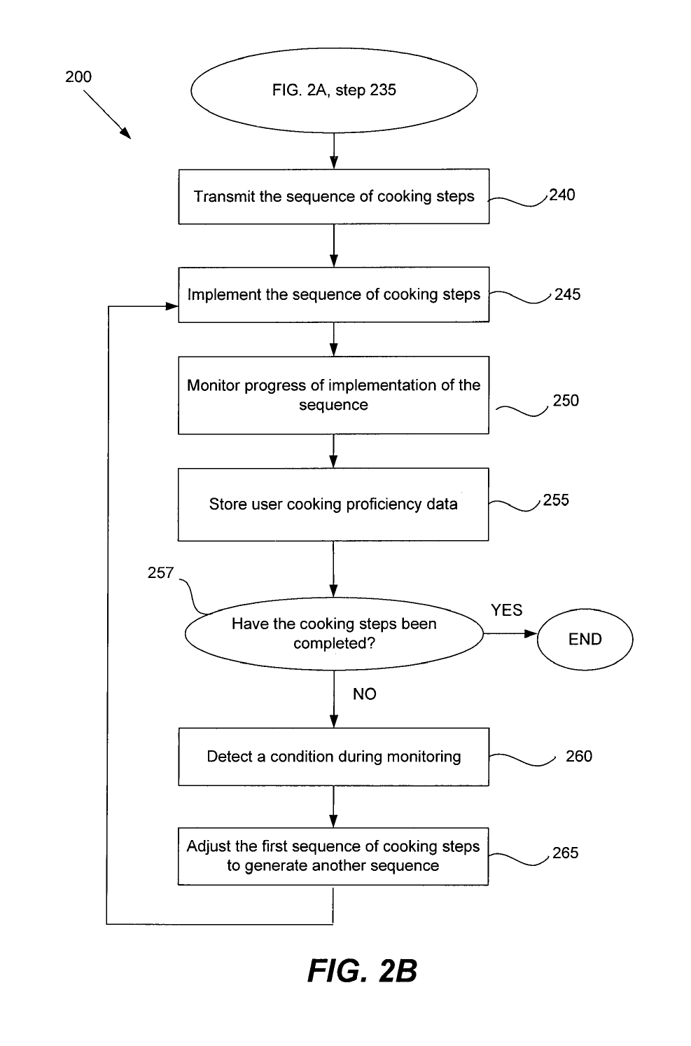

In some cases, during the above monitoring process, the system will detect a new condition that triggers a reordering of the cooking steps. For example, a user may take too long on a particular step, or finish a step much more quickly than expected. Under some conditions, the coordinating device 105 will then adjust the sequence of cooking steps and generate a new sequence, which is then distributed to the appliances as appropriate. The new sequence takes into account this new condition and is designed to further improve and refine the cooking process. This may involve reordering particular steps, or causing different steps to be performed in parallel. This process may be repeated until the dish is successfully completed. Further details regarding the operations performed by the appliances 110a/110b and the coordinating device 105 of FIG. 1 will be described in connection with FIGS. 2A, 2B and 3-6.

Referring next to FIGS. 2A and 2B, an example method 200 for guiding a user through a recipe will be described. The method 200 is implemented using the cooking guidance system illustrated in FIG. 1.

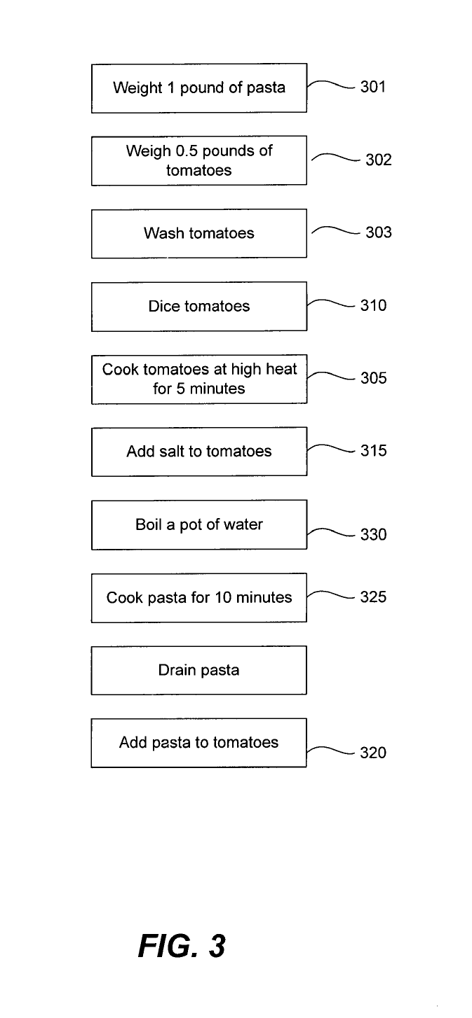

Initially, at step 205, the coordinating device 105 obtains one or more recipes. A recipe indicates one or more cooking steps that help instruct a user to make a particular dish, beverage or other consumable good. The cooking steps of an example recipe for making tomato pasta are illustrated in FIG. 3. Some of the illustrated steps include, “weigh 1 pound of pasta,” “dice tomatoes,” and “cook pasta for 10 minutes.”

The steps illustrated in FIG. 3 are similar to what appears in a conventional cookbook, in which the steps of a recipe are arranged in chronological order. When using a typical cookbook, a cook is given little additional information, and is generally left to his or her own devices to figure out exactly how to perform the cooking steps. However, various implementations of the present invention involve associating each cooking step with a variety of different types of information and data. The coordinating device 105 uses the information and data to make the cooking process more efficient and/or properly coordinate the operations of the different appliances.

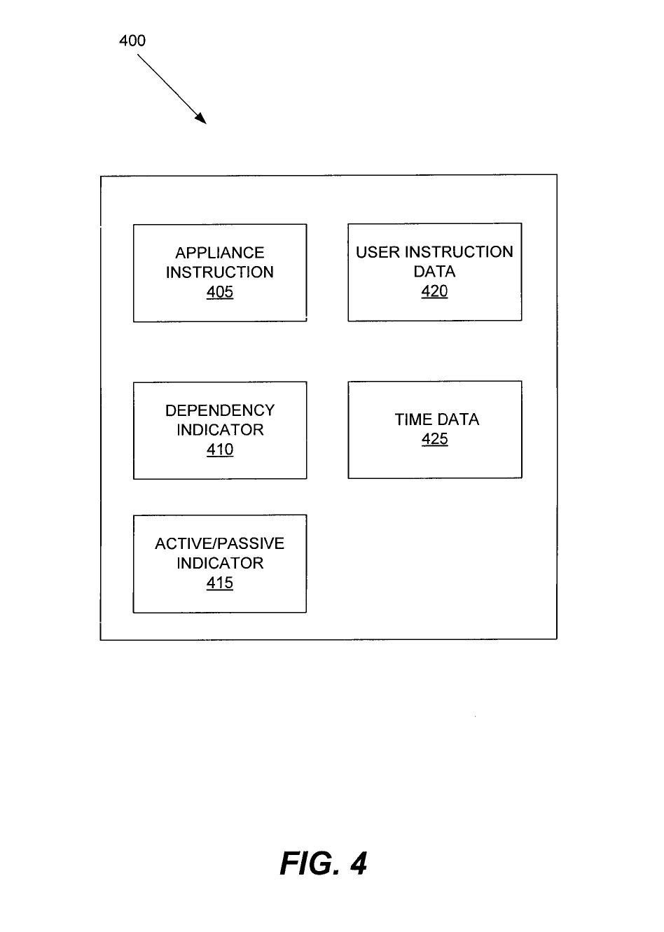

FIG. 4 illustrates a cooking step data frame 400, which is an example of how different types of data can be associated with each cooking step. The cooking step data frame 400 may be any data that represents various characteristics of a cooking step and helps control how a user is guided through the step. In the illustrated embodiment, each cooking step of a recipe (e.g., the cooking steps of FIG. 3) is represented by a distinct cooking step data frame 400.

In this example, the cooking step data frame 400 includes an appliance instruction 405, user instruction data 420, time data 425, a dependency indicator 410 and an active/passive indicator 415. It should be noted that although the aforementioned components are illustrated as being parts of the data frame, this is not a requirement. In other embodiments, for example, each of the components represent distinct data blocks or fields that are associated with one another and are stored in any suitable data storage system e.g., a database.

The appliance instruction 405 indicates one or more commands to the appliance. By way of example, assume that the cooking step data frame 400 is associated with cooking step 305 of FIG. 3, which involves cooking tomatoes at high heat. In this example, the appliance instruction 405 may indicate the following commands to an appliance 110a (e.g., a gas range): 1) display a message to the user; 2) request input from the user to proceed; and 3) generate heat at a selected burner for five minutes.

The user instruction data 420 includes any data used to display information for or communicate information to a user 120. In this example, the cooking step data structure 400 is associated with step 305 of FIG. 3, which involves cooking tomatoes at high heat. Thus, the user instruction data 420 may include a video or movie that shows how to properly cook and stir the tomatoes. Alternatively or additionally, the user instruction data 420 may include cooking instructions that the appliance will display to a user and that help guide the user in performing the cooking step. In some implementations, the user instruction data 420 includes an audio file that includes audio instructions that are played out of a speaker on the appliance 110a and that guide the user 120 through the cooking step.

The dependency indicator 410 is any data that indicates whether the associated cooking step must follow or precede one or more other cooking steps. Continuing the above example, in the illustrated embodiment, the dependency data 410 indicates that the cooking step 305 of FIG. 3 associated with data frame 400 (i.e., cooking tomatoes at high heat for five minutes) must come after cooking step 310 (i.e., dice tomatoes) in FIG. 3 and come before cooking step 315 (i.e., add salt to tomatoes) and cooking step 320 (i.e., add pasta to tomatoes.) In some implementations, the dependency data also indicates other characteristics related to a particular dependency, such as whether the cooking step must immediately follow another step, or whether the associated cooking step can be performed any time or within a predetermined time period after another step.

The time data 425 indicates any time-related characteristics of the associated cooking step. In various embodiments, for example, the time data 425 indicates an estimation of a time period that will be required to complete the cooking step. As will be discussed later in the application, the coordinating device 105 may adjust this time period based on various parameters, such as the experience level of the user who is performing the associated cooking step. In other embodiments, the time data 425 may also indicate multiple phases for the cooking operation, each with its own time period. For example, the cooking step 325 of FIG. 3, which involves cooking pasta for 10 minutes, may involve two time periods: placing pasta in a pot, which is estimated to take 1 minute, and heating the pot of pasta, which is estimated to take 9 minutes.

The active/passive indicator 415 is any data that indicates whether a user needs to personally and actively attend to the associated cooking step, or whether the user can perform another task while the associated cooking step is being performed. By way of example, step 310 of FIG. 3 involves dicing tomatoes, and thus its associated active/passive indicator indicates that a user must be actively involved in the step. By contrast, step 330 of FIG. 3 involves boiling a pot of water, and thus its associated active/passive indicator indicates a user is free to perform other activities while the water is being boiled. In various implementations, the coordinating device 105 uses the active/passive indicators for each of the cooking steps to determine which cooking steps can be performed in parallel.

Returning to FIG. 2A, at step 210, the coordinating device 105 identifies one or more users. This may be done using any suitable identification protocol or system. In some embodiments, for example, the coordinating device 105 includes a display screen showing a user interface. Each user 120 interacts with the display screen (e.g., provides a finger for a fingerprint scan, types in a username and/or password, enters their name, etc.) to provide their identity. Some implementations involve a coordinating device 105 that includes a microphone and speaker. The speaker generates an audio request, asking for the user's name, username and/or password, and the microphone receives the audio response from the user and uses it to identify the user 120. In various embodiments, the coordinating device 105 automatically identifies each user by communicating with a device carried by the user (e.g., by using a Bluetooth or WiFi connection to obtain identification data from the user's smart phone or smart watch.)

At step 213, the coordinating device 105 determines which appliances are available on the network 130. More specifically, the coordinating device determines whether there are any appliances on the network that are capable of communicating with and responding to commands from the coordinating device. In the illustrated embodiment of FIG. 1, for example, the coordinating device determines that there are two “smart” appliances on the network, appliance 110b (a scale) and appliance 110a (a oven with a gas range.) At this step, the coordinating device 105 determines the capabilities of each appliance, which may affect how the coordinating device 105 guides users through the cooking process.

At step 215, the coordinating device 105 determines the cooking proficiency of each identified user. In various embodiments, for example, the coordinating device 105 searches a database (e.g., stored at the device 105 or at a remote server) to find a profile for each identified user. The profile may include any information that helps indicate a cooking skill and experience of the user. By way of example, the profile may include records indicating how many times the user has used the cooking guidance system 100 to cook similar or the same dishes. In some implementations, the profile includes data inputted manually by the user e.g., information that the user previously provided based on a self-evaluation of his or her skill at cooking.

Based on the profile and any other suitable data, the coordinating device determines a cooking proficiency of the user. This may be represented using any suitable rating or scale system (e.g., a level number, a title, etc.) In some implementations, the determined cooking proficiency level is based on crowdsourced data collected by a server from multiple cooking guidance systems 100. That is, the server has collected data on the cooking efforts of many users. The data indicates how users with different amounts of cooking experience performed at various cooking tasks e.g., based on monitoring steps 245 and 250.) Based on the crowdsourced data and the user profile, the coordinating device determines the cooking proficiency of the user.

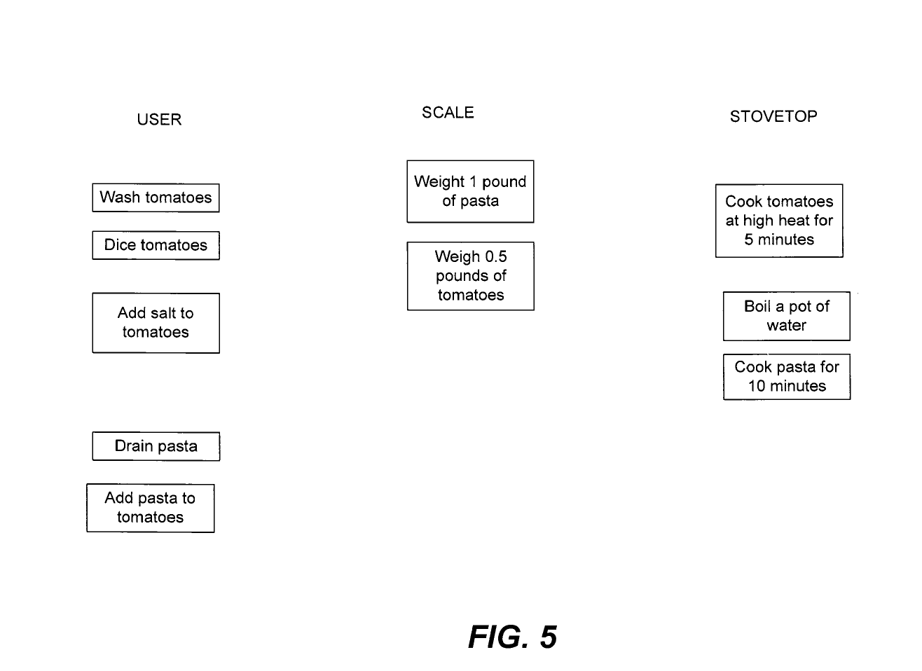

The coordinating device then associates each cooking step with a particular appliance and/or user (step 220). This step may be based on data associated with the cooking step e.g., the appliance instruction 405 of the cooking step data frame 400, which can indicate which or what kind of appliance can be used to perform the step. An example of this association operation is illustrated in FIG. 5. In FIG. 5, steps such as washing tomatoes or dicing tomatoes are associated with a user and not to a specific appliance. Any step involving weighing is associated with appliance 110b, which in this example is a scale. Steps such as cooking tomatoes or boiling water are associated with appliance 110a, which in this example is an oven with a gas range.

If there are multiple users, the coordinating device may assign different cooking steps to different users. This assignment may be based on the cooking proficiency determined for each user in step 215. For example, the coordinating device 105 may assign a particularly complex or difficult cooking step to a user with a higher proficiency level.

Returning to FIG. 2A, at step 225, the coordinating device 105 determines dependencies between the cooking steps. That is, the coordinating device 105 determines, for each step, which other steps must precede or follow the step. This determination may be based on data associated with the step e.g., the dependency indicator 410 of the associated cooking step data frame 400 of FIG. 4.

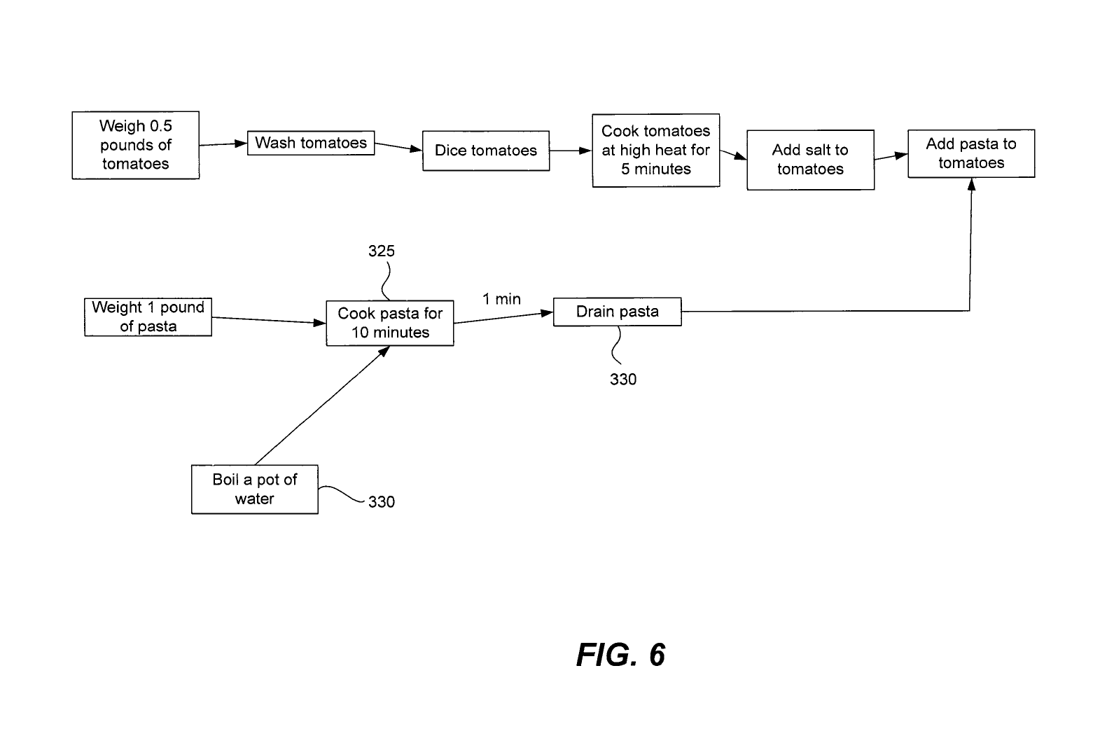

An example of the dependency determination is illustrated in FIG. 6. FIG. 6 is a diagram including the steps illustrated in FIG. 3. The arrows between the steps indicate dependencies. Thus, the arrow drawn from the cooking step 330 (boil a pot of water) to the cooking step 325 (cook pasta for 10 minutes) indicates that step 325 depends on step 330 i.e., that the pot of water must be boiled before the pasta can be cooked.

In some implementations, the coordinating device 105 determines that a particular step must not only follow another step, but must immediately follow that stop or be performed within a predefined time period of the completion of another step. (This determination may be indicated by the data associated with the cooking step i.e., the dependency indicator 410 of FIG. 4.) In the illustrated embodiment, for example of FIG. 6, the coordinating device 105 determines that the pasta must be drained (step 330) within 1 minute of the time that the pasta has finished cooking (step 325). This is to prevent the pasta from soaking too long, which may ruin its texture and flavor. Such determinations can affect how the coordinating device 105 sets the order for the cooking steps, as will be discussed later in the application.

At step 230, the coordinating device 105 determines an estimated completion time for each step. This determination may be based on a variety of parameters. In some implementations, for example, each cooking step is associated with data indicating a base estimated time required to complete the step (e.g., the data may be indicated by the time data 425 of the associated cooking step data frame 400 of FIG. 4.)

The coordinating device 105 may accept the base estimated time. Alternatively, the coordinating device 105 may adjust the base estimated time based on the user who will perform the step (e.g., as determined in step 220) and his or her cooking proficiency (e.g., as determined in step 210). By way of example, if the cooking step involves chopping multiple vegetables, the device 105 may determine that the cooking step will take much longer for a cooking novice to complete than if the user was a cooking expert.

Returning to FIG. 2A, at step 235, the coordinating device 105 determines a sequence of cooking steps. More specifically, the coordinating device 105 determines the order in which the cooking steps should be performed and/or which steps (if any) should be performed in parallel. The determination of the sequence of cooking steps may be based on a variety of factors, including the cooking proficiency of the user performing each step, the estimated completion time for each step, whether each step requires the active participation of the user, the number of users, and any other suitable parameter (e.g., any data of any data component of the associated cooking step data frame 400 of FIG. 4.) In various embodiments, the coordinating device 105 determines the sequence automatically without the direct involvement of any user i.e., without the user specifying which cooking step comes before another cooking step.

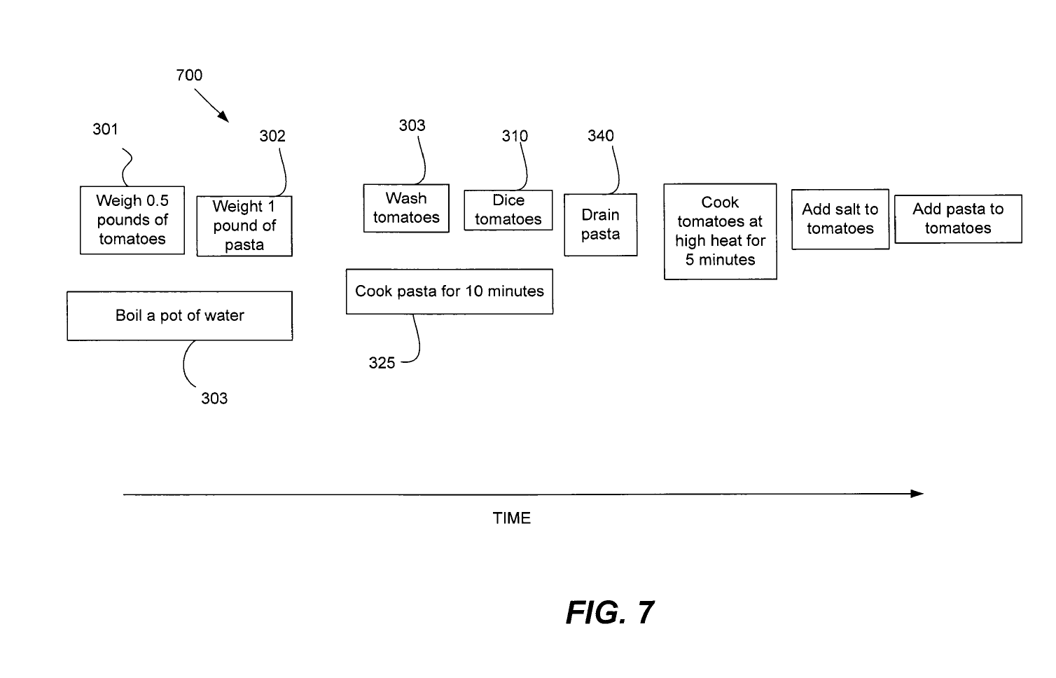

An example of a sequence 700 of cooking steps is illustrated in FIG. 7. FIG. 7 is a diagram of the various cooking steps illustrated in FIG. 3. The X axis of the diagram represents time. That is, the chronological order of the steps is left to right. Some steps are stacked over one another, indicating that the steps are performed in parallel. Accordingly, the step 301 (weigh 0.5 pounds of tomatoes) and step 302 (weigh one pound of pasta) are positioned over the step 303 (boil water.) Step 303 begins slightly before steps 301 and 302. This indicates that the user should start the boiling of the water, and while the water is boiling, weigh the tomatoes and pasta.

Referring next to FIG. 2B, the method 200 of FIG. 2A continues with step 240. At step 240, the coordinating device 105 transmits the sequence 700 of cooking steps to the appliances 110a/110b. More specifically, the coordinating device 105 transmits data (e.g., cooking step data frame 400 of FIG. 4) relating to a particular cooking step to the associated appliance so that the step can be properly performed there. Additionally, in some implementations, the coordinating device 105 transmits data indicating to each appliance when each associated cooking step should be performed based on the order of the sequence 700. The appliance 110a/110b is then in a position to communicate a message to the user at the appropriate time to prompt then to come to the appliance to start working on the associated cooking step.

At step 245, the coordinating device 105 and/or the appliances 110a/110b implement the sequence of cooking steps determined in step 235. The cooking steps may be implemented in a wide variety of ways. In some embodiments, for example, the coordinating device 105 actively coordinates the operation of the appliances 110a/110b. By way of example, in various approaches, the appliances 110a/110b wait for a request from the coordinating device. Following the order in the sequence determined in step 245, the coordinating device 105 sends a request to each appliance that is associated with the next step in the sequence, which enables the appliance to receive user input, prompt the user and perform its assigned function. When a particular cooking step is completed, the associated appliance transmits a completion signal back to the coordinating device 105. In response, the coordinating device 105 moves to the next cooking step and/or appliance in the sequence and repeats the above process. (It is possible that a cooking step will not be associated with a particular “smart” appliance 110a/110b and must be performed by a user without the assistance of a tool that communicates with the cooking guidance system 100. In that case, in various implementations, the coordinating device 105 itself receives user input, prompts the user and/or guides the user through the step.)

An example implementation of a recipe may be described as follows. A user uses the cooking guidance system 100 to complete a recipe for tomato pasta. The coordinating device 105 obtains the recipe (step 205), which is organized into multiple cooking steps. Each cooking step is associated with data (e.g., cooking step data frames 400 of FIG. 4) Based on the data, the coordinating device determines a sequence of cooking steps (step 235), as shown in FIG. 7. The coordinating device transmits data relating to each cooking step (e.g., data frames 400) to each associated appliance (step 240).

The first cooking step is to start the boiling of water (step 303 of FIG. 7.) The coordinating device 105 displays a message, prompting the user to put water in a pot and to bring it to the appliance 110a (an oven with a gas range.) The coordinating device 105 transmits a message to the oven/gas range. In response, the oven/gas range also displays a message, indicating that the user should place the pot on one of the gas burners and press a button. The message is based on cooking step data that was received from the coordinating device (e.g., the user instruction data 420 of the cooking frame 400.) Once the user does this, the appliance automatically ignites the gas burner and sets it at a desired intensity/temperature, based on the cooking step data (e.g., the appliance instruction 405 of the data frame 400.) That is, in various implementations, the user is not required to start and/or set the intensity of the burner manually.

Afterward, the appliance 110a transmits a message back to the coordinating device 105, indicating that the water is beginning to boil. In response, the coordinating device 105 references the sequence illustrated in FIG. 7 and determines that the user should now weigh 0.5 pounds of tomatoes (step 301 of FIG. 7.) A process somewhat similar to the one above is then repeated: the coordinating device 105 displays a message, indicating that the user should obtain some tomatoes and go to the appliance 110b (e.g., a scale.) The coordinating device 105 transmits a message to the appliance 110b, which in response displays guidance information (e.g., “please place tomatoes on the scale until you are told to stop”) and helps the user complete his or her task. Once the task is completed, the appliance transmits a message to the coordinating device 105, and the coordinating device 105 moves on to the next cooking step.

It should be appreciated that the above process represents only a single, exemplary implementation, which may be modified as appropriate for different applications. By way of example, in some embodiments, the appliances may be able to communicate directly with one another and inform one another when one cooking step has been completed and another step should be started, without requiring repeated, direct involvement by the coordinating device 105. Generally, this application contemplates various ways of implementing the cooking guidance system 100 that may depart from what is described above.

Returning to method 200 of FIG. 2B, at step 250, the coordinating device 105 and/or the appliances 110a/110b monitor the implementation of the sequence of cooking steps. This monitoring process may be performed in a wide variety of ways, depending on the needs of a particular application and the capabilities of the devices in question. In some embodiments, for example, a device (i.e., the coordinating device 105 or an appliance 110a/110b) issues a series of prompts. That is, the device requests input from the user indicating whether he or she is ready to start a cooking step. The device also later requests input from the user indicating whether the step was completed or not.

The cooking guidance system 100 may also include one or more sensor that are used to monitor the progress made in the performance of the cooking steps. Such sensors may be part of the coordinating device 105 and/or the appliances 110a/110b. Alternatively or additionally, they may be independent sensors that are coupled with the network 130. The sensors gather data and transmit it to the coordinating device 105 for analysis.

A wide variety of sensors may be used, including but not limited to a probe (for detecting the internal temperature of foods), moisture/humidity sensors (for detecting, for example, whether a soup or water is boiling), a camera (for monitoring changes in color or texture), infrared sensors (for measuring temperature), a microphone (for detecting particular sounds like sizzling or crackling) and a smoke detector (for detecting charring or burning.) Based on the received sensor data, the coordinating device 105 may determine that a cooking operation is underway (e.g., a humidity sensor detects that water is boiling), that a cooking operation is completed (e.g., a camera detects that a shrimp is done based on a change in the color of the shrimp) or that a problem has arisen (e.g., a smoke detector detects burning.)

The use of sensors can eliminate the need for a person to closely monitor and provide feedback on a cooking process. To use a simple example, consider a cooking step in which a user must simmer a stew for a period of time. In response to a prompt from an appliance (e.g., an oven with a gas range) the user places a pot of the stew on a burner of the appliance. A humidity sensor is positioned above the stew and detects when the stew has reached the desired temperature. After the desired simmer temperature is reached, the sensor sends a message to the appliance. In response, the appliance starts a timer. After a desired, predefined time period has passed, the appliance then displays a message, indicating to the user that the stew has been simmered long enough. The appliance also automatically deactivates the burner. The appliance thus is able to determine that the cooking operation was successfully completed without requiring a confirmation or direct feedback from the user.

In various implementations, a device (i.e., the coordinating device 105 and/or an appliance 110a/110b) will track the actions of a user as he or she works with the device to complete a cooking step. In some implementations, for example, the device stores data indicating what actions the user performed to finish a cooking step, how long each of those actions took, whether the cooking step was completed successfully, etc. In one implementation, the device includes a video camera that records a video of the user performing the associated cooking step. If the user makes a mistake, the device may later display the video to the user to help them understand how to avoid such mistakes in the future.

At step 255, the coordinating device 105 stores user cooking proficiency data. That is, as described above, various devices (e.g., the coordinating device 105, the appliances 110a/110b and sensors) track and monitor a user's efforts to complete a cooking step. As appropriate, this data is transmitted to the coordinating device 105, where it is stored. Such data is helpful in assessing the cooking proficiency of the user performing the step. Alternatively or additionally, the coordinating device transmits the information to an external device (e.g., a remote cloud server) for storage therein. Based on the collected information, the coordinating device 105 may update a user profile that indicates the user's cooking proficiency (e.g., as discussed in connection with step 215.) When the user attempts other recipes in the future using the cooking guidance system 100, the coordinating device 105 will then be able to take into account the updated profile when determining the amount of time needed for particular cooking steps and the sequence of the cooking steps (e.g., steps 215, 220, 230 and 235.)

The above steps may be implemented until all the cooking steps and the recipe have been completed (step 257). However, under some conditions and before all the steps are completed, the coordinating device 105 and/or the cooking guidance system 100 detect that a particular condition has arisen that may require adjustment of the cooking process (step 260). Any suitable condition may trigger such an assessment. In some implementations, for example, the coordinating device 105 detects that a user has failed to complete a cooking step within an expected period of time (e.g., as estimated in 230.) On the other hand, the coordinating device 105 may instead detect that the user has completed a cooking step early relative to the expected period of time.

Some implementations involve an appliance 110a/110b and/or coordinating device 105 detecting that some sort of problem has occurred that will require a reassessment and reformulation of the cooking steps. By way of example, an appliance 110a/110b may include or be coupled with a sensor that detects smoke or the burning of food. Alternatively, the appliance or sensor may detect that a food has been cooked or boiled too long, that too much of an ingredient (e.g., salt, sugar) has been added to a food, etc.

When any of the above conditions is detected, the coordinating device 105 analyzes the detected condition and determines what kind of action should be undertaken. In some situations, the condition may not require any change in the previously determined sequence of cooking steps. In some cases, however, the coordinating device 105 determines that changes must be made and it adjusts the sequence of cooking steps (step 265). That is, the coordinative device determines a new, second sequence in which some of the cooking steps are modified, reordered and/or removed. The adjustment takes into account the condition detected in step 260 and generally is intended to improve the effectiveness and efficiency of the cooking process.

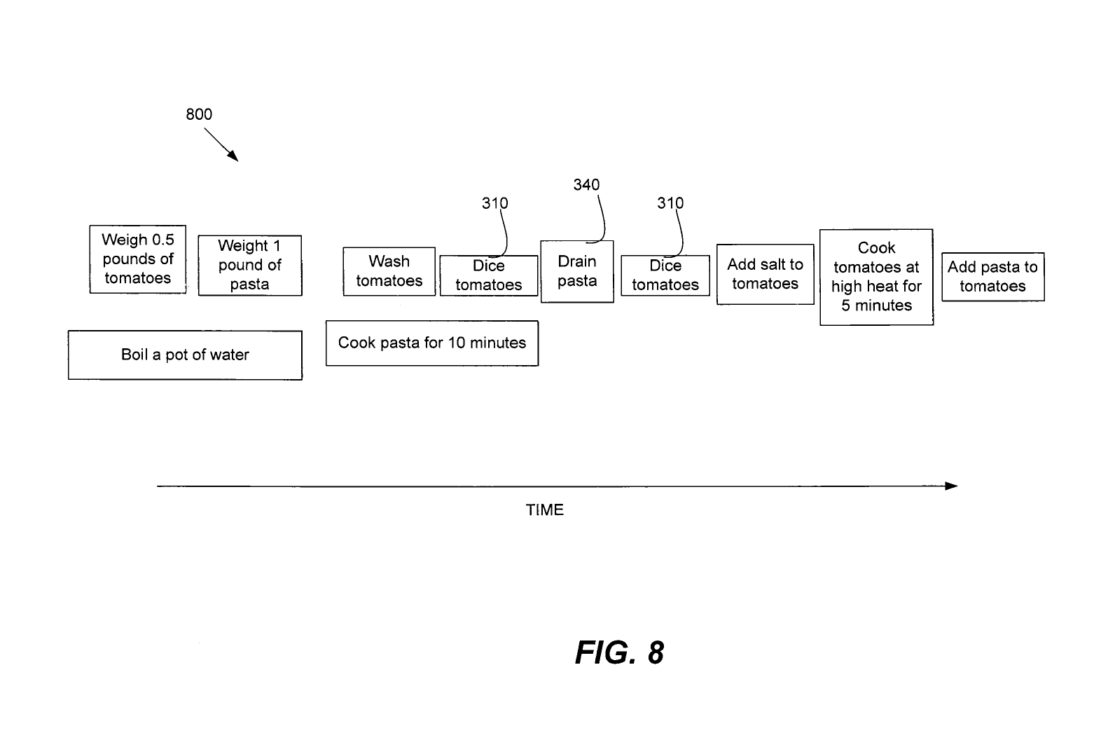

An example of the aforementioned adjustment will be described with reference to FIG. 8. FIG. 8 indicates a new sequence of cooking steps, which has been adjusted based on the cooking steps indicated in FIG. 7. The earlier sequence illustrated in FIG. 7 indicated that the user should cook pasta for 10 minutes (step 325). During that time, the user can wash and then dice tomatoes (steps 303 and 310), and was expected to finish the dicing of tomatoes in time to drain the pasta (step 340.)

In this example, however, the user was unable to dice the tomatoes in time e.g., the user was distracted by something and was simply much slower at dicing tomatoes than expected. To indicate that the user was finished dicing the tomatoes, the user should have provided feedback (e.g., a verbal command, a pushing of a button on a display screen of the coordinating device 105, etc.) to the coordinating device 105, but did not do so. As a result, the coordinating device 105 detected that the user was taking longer than expected to dice the tomatoes (step 260).

Based on the detected condition, the coordinating device 105 adjusts the sequence of cooking steps in FIG. 7 to generate a new, second sequence 800 of cooking steps as shown in FIG. 8. A review of FIG. 8 reveals that the new sequence 800 requires the user to interrupt the dicing of tomatoes (step 310), drain the pasta (step 340), and then recontinue dicing the tomatoes. This is because the pasta, if not drained immediately, would absorb too much liquid and lose its flavor. Based on this assessment, the coordinating device 105 communicates a message to the user (e.g., by displaying it on a screen or generating an audio message) indicating that the user should stop dicing tomatoes and should drain the pasta. Additionally, the coordinating device 105 communicates a message indicating that the user, when finished draining the pasta, should provide a confirmation of this to the device 105. Once the confirmation input is received, the device 105 in response communicates a message indicating that the user should continue dicing the tomatoes.

Once the sequence of cooking steps is adjusted, the method 200 proceeds back to step 250. That is, the remaining steps are implemented and monitored as discussed in connection with steps 245, 250, 255 and 260. Thus, in some cases a sequence of cooking steps for a recipe may be adjusted multiple times, if necessary. This process continues until all of the cooking steps for all of the recipes obtained in step 205 have been completed.

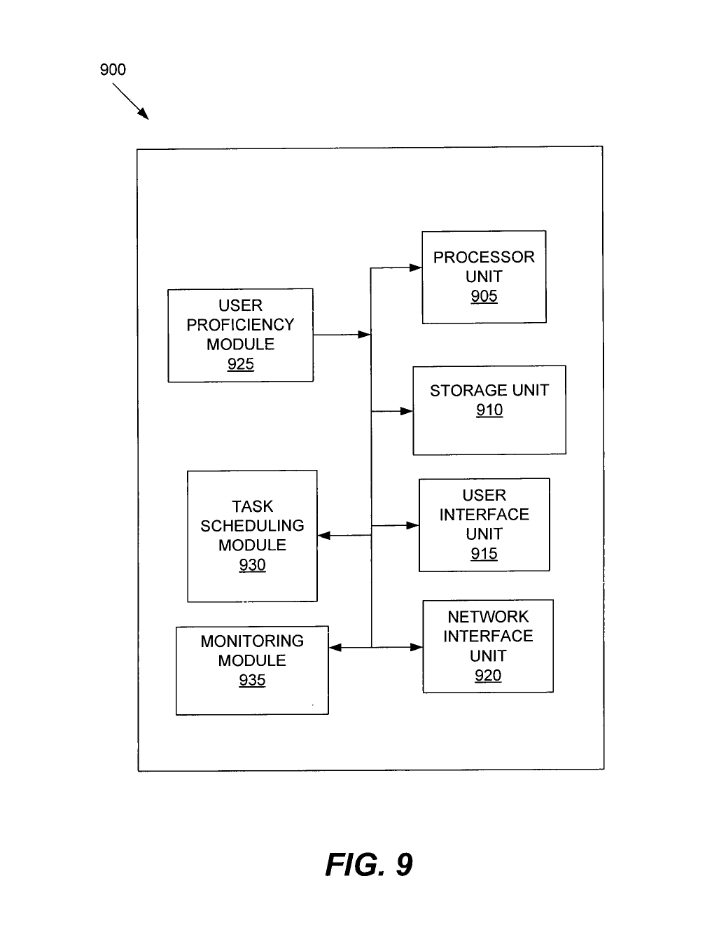

Referring next to FIG. 9, a coordinating device 900 according to a particular embodiment of the present invention will be described. The coordinating device 900 may be any coordinating device described in this application (e.g., coordinating device 105 of FIG. 1.) The coordinating device 900 may be any suitable device, including but not limited to a refrigerator, a smart phone, a tablet, a laptop, a computing device, a television, a kitchen appliance, etc. The coordinating device 900 includes a processor unit 905 including one or more processors, a storage unit 910, a user interface unit 915, a network interface unit 920, a user proficiency module 925, a task scheduling module 930 and a monitoring module 935.

The storage unit 910 is any hardware or suitable for storing data or executable computer code. The storage unit 910 can include but is not limited to a hard drive, flash drive, non-volatile memory, volatile memory or any other type of computer readable storage medium. Any operation or method for a coordinating device that is described in this application (e.g., method 200 of FIGS. 2A-2B) may be stored in the form of executable computer code or instructions in the storage unit 910. The execution of the computer code or instructions by the processor unit 905 causes the coordinating device 900 or a suitable device coupled with the device 900 to perform any of the aforementioned operations or methods.

The network interface unit 920 includes any hardware or software suitable for enabling the coordinating device 900 to communicate with external devices. In some embodiments, for example, the coordinating device 900 transmits messages, commands, cooking steps and associated data (e.g., cooking step data frames 400 of FIG. 4) to one or more appliances 110a/110b using the network interface unit 920 (e.g., step 240 of FIGS. 2A-2B.) The coordinating device 900 also uses the network interface unit 920 to receive sensor data and monitoring data from the appliances 110a/110b (e.g., steps 245 and 250 of FIG. 2B.) The network interface unit 920 is arranged to transmit data and receive data using any suitable network (e.g., LAN, Internet, etc.) or communications protocol (e.g., Bluetooth, WiFi, NFC, IEEE 802.15.4, IEEE 802.11, etc.)

The user interface unit 915 is any hardware or software arranged to communicate information to a user 120 and/or receive input from the user 120. The user interface unit 915 includes any suitable display technology used to display information e.g., a touch sensitive (capacitive) screen, an e-ink display, an LCD or OLED display, etc. The user interface unit 1000 may display any kind of message or information described herein at the display unit 1020 e.g., as discussed in connection with method 200 of FIGS. 2A-2B. Alternatively or additionally, the user interface unit 1020 can communicate messages to a user through a speaker e.g., using an audio message.

In some implementations, the user interface unit 915 also includes a display screen that is arranged receive input from the user e.g., the user is able to press buttons on a touch-sensitive display and provide feedback on whether a cooking step is completed. The unit 915 may receive input using any other suitable type of hardware as well e.g., a mechanical button, a microphone for receiving audio commands, etc. Any user communication to the coordinating device 900 or any communication from the coordinating device 900 to the user 120 that is described in this application may be implemented using the user interface unit 915.

The user proficiency module 925 is any hardware or software that is used to perform operations related to the determination of a cooking proficiency of a user (e.g., step 215 of FIGS. 2A-2B.) By way of example, the module 925 is arranged to store data on the user's past cooking experiences and/or cooking profile, search the data and estimate the cooking proficiency of the user based on the data. In various embodiments, data related to the current performance of any cooking steps is stored using the user proficiency module (e.g., as described in connection with step 255.)

The task scheduling module 930 is any hardware or software that is used to perform operations related to the generation of a sequence of cooking steps. In various embodiments, the module 930 is arranged to obtain a recipe (e.g., step 205 of FIGS. 2A-2B) and cooking steps, determine characteristics of each cooking step (e.g., steps 220, 225 and 230) and determine a sequence of cooking steps (e.g., step 235.) The task scheduling module 930 also receives data from the monitoring module 935 and, based on the data, selectively adjusts a sequence to generate a new sequence (e.g., step 265.)

The monitoring module 935 is any hardware or software that is used to perform operations relating to the monitoring of the cooking process. In various embodiments, the monitoring module is arranged to receive monitoring data (e.g., sensor data) from a variety of sensors, monitoring devices and/or appliances 110a/110b. In some embodiments, based on the data, the monitoring module 935 determines whether one or more predetermined conditions have taken place (e.g., as discussed in connection with steps 250 and 260 of FIGS. 2A-2B.) This determination and/or the received monitoring is data is transmitted to the task scheduling module 930 for further processing.

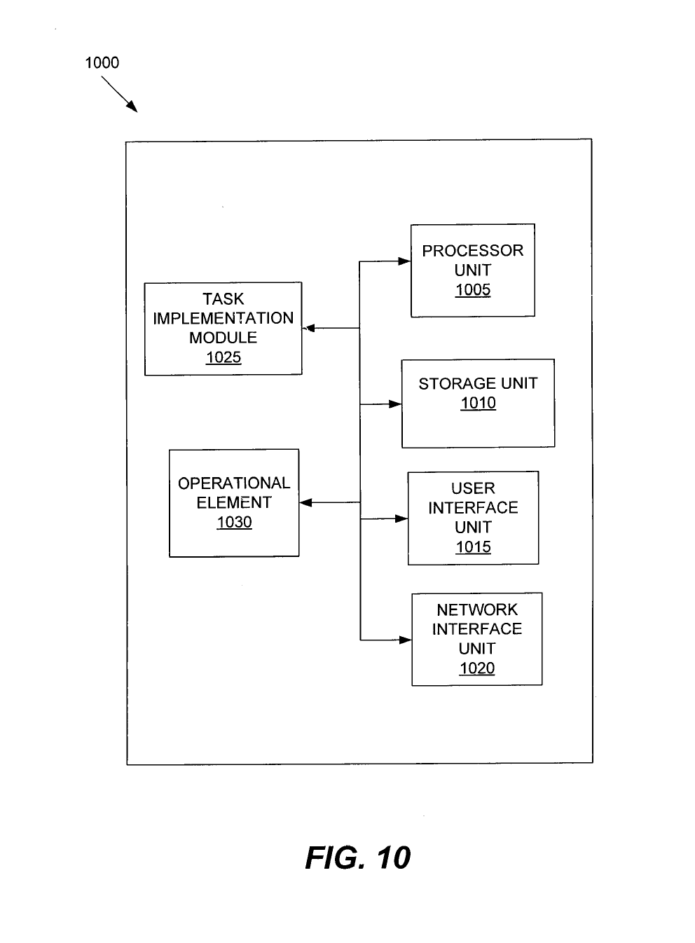

Referring next to FIG. 10, an appliance 1000 according to a particular embodiment of the present invention will be described. The appliance includes a processor unit 1005 including one or more processors, a storage unit 1010, a user interface unit 1015, a network interface unit 1020, a task implementation module 1025 and an operational element 1030. The appliance 1000 may be any suitable kitchen-, food- or cooking-related appliance (e.g., appliances 110a/110b of FIG. 1), including but not limited to a scale, oven, gas/electric range, toaster, stove, food processor, refrigerator, coffee machine and blender.

The storage unit 1010 is any hardware or suitable for storing data or executable computer code. The storage unit 1010 can include but is not limited to a hard drive, flash drive, non-volatile memory, volatile memory or any other type of computer readable storage medium. Any operation or method for an appliance that is described in this application (e.g., as described in method 200 of FIGS. 2A-2B) may be stored in the form of executable computer code or instructions in the storage unit 1010. The execution of the computer code or instructions by the processor unit 1005 causes the appliance to perform any of the aforementioned operations or methods.

The network interface unit 1020 includes any hardware or software suitable for enabling the appliance to communicate with external devices. In some embodiments, for example, the appliance 1000 monitors the implementation of a cooking step and the cooking performance of a user. The appliance then uses the network interface unit 1020 to transmit the monitoring data to the coordinating device for further processing (e.g., as described in connection with step 250 of FIG. 2B.) The appliance also uses the network interface unit 1020 to receive data from the coordinating device, such as cooking steps, recipes, commands, prompt and cooking step data frames (e.g., as described in step 240 of FIG. 2.) The network interface unit 1020 is arranged to transmit data and receive data using any suitable network (e.g., LAN, Internet, etc.) or communications protocol (e.g., Bluetooth, WiFi, NFC, IEEE 802.15.4, IEEE 802.11, etc.)

The user interface unit 1015 is any hardware or software arranged to communicate information to a user and/or receive input from the user. In some embodiments, the user interface unit 1015 includes a display technology used to display information e.g., a touch sensitive (capacitive) screen, an e-ink display, an LCD or OLED display or any other suitable display technology. The appliance 1000 may display any kind of message or information described herein at the user interface unit 1015 e.g., as discussed in connection with method 200 of FIGS. 2A-2B. Alternatively or additionally, the user interface unit 1015 includes a speaker which the appliance 1000 uses to communicate messages to a user e.g., using an audio message or sounds.

In some implementations, the user interface unit 1015 also includes a display screen that is arranged receive input from the user e.g., the user is able to press buttons on a touch-sensitive display and provide feedback on whether a cooking step is completed. The unit 1015 may receive input using any other suitable type of hardware as well e.g., a mechanical button, a microphone for receiving audio commands, etc. Any user communication to the appliance 1000 or any communication from the appliance 1000 to the user that is described in this application may be implemented using the user interface unit 1015.

The task implementation module 1025 is any hardware or software arranged to help perform a cooking step. In various embodiments, the module 1025 is arranged to receive cooking step-related data from the coordinating device (e.g., prompts, commands, cooking step data frames 400 of FIG. 4, etc.). Based on the data, the module 1025 is arranged to prompt a user to begin the cooking step and to guide the user through the step. As appropriate, the task implementation module 1025 provides audio or video content to the user interface unit 1015 so that it can be conveyed to the user. Additionally, the module 1025 receives input from the user 120 through the user interface unit 1015 and is arranged to respond to that input. Based on the cooking step data and instructions received from the coordinating device and/or the user, the module is further arranged to perform operations using the operational element 1030 (e.g., ignite a burner, set an oven to the correct temperature, set a timer, turn off a burner or oven, etc.) Generally, the module 1025 is arranged to perform any action described in this application that relates to the guidance of a user and the implementation of a cooking step at the appliance (e.g., as discussed in connection with steps 245 and 250.)

The operational element 1030 is any hardware or software used to perform a cooking- or food preparation-related function. The operational element is different, depending on the nature of the appliance. By way of example, if the appliance 1000 is an oven with an electric range, the operational element may include the electric range and the oven, electric burners, a heating compartment (for baking) and a heating element in the compartment. If the appliance 1000 is a scale, the operational element 1030 may include a weighing platform and software and/or a system for determining a weight of an object that is resting on the platform. If the appliance 1000 is a blender, the operational element 1030 may include a container for holding food or a liquid and a base upon which the container is mounted. In various implementations, the operational element 1030 includes any equipment, mechanisms or structures that an appliance is known to generally include to perform its (primary) food preparation- and/or cooking-related function. The operational element 1030 is arranged to receive input from the task implementation module 1025 and to perform operations based on the input.

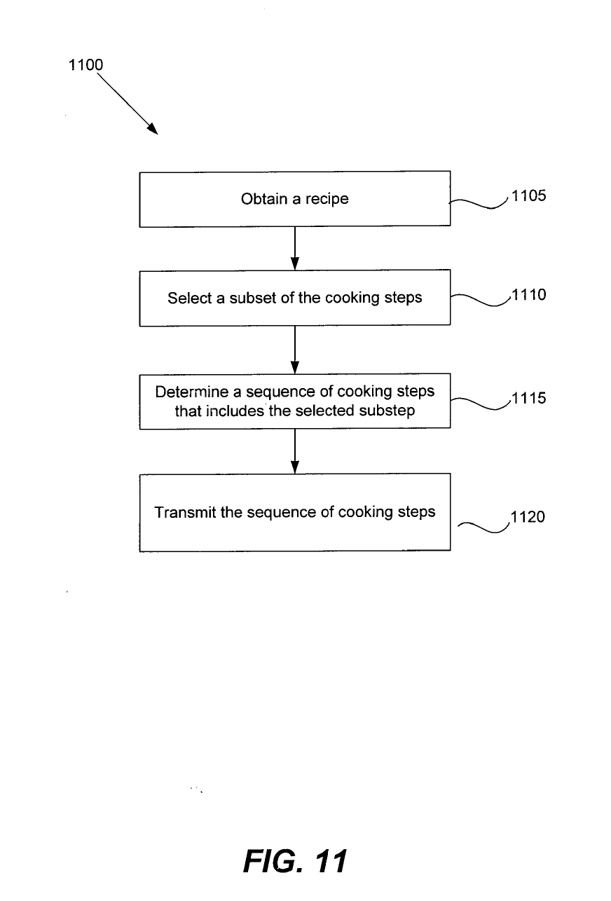

Referring next to FIG. 11, a method 1100 for selecting a subset of cooking steps for a recipe according to a particular embodiment of the present invention. In some implementations, a particular recipe is associated with multiple cooking steps, all of which are not required to implement or complete the recipe. Put another way, one or more steps are interchangeable e.g., one step can be substituted for another. In various embodiments, the coordinating device 105 thus selects a subset of the cooking steps for a recipe, but not all of the cooking steps for a recipe. The selection of the desired subset may depend on a variety of conditions and factors, as will be described in more detail below. It should be noted that any or all of the steps of the method 200 of FIGS. 2A-2B may be incorporated into method 1100. The method 1100 may be implemented using the coordinating device 105 and the cooking guidance system 100 illustrated in FIG. 1.

At step 1105 of method 1100, the coordinating device 105 obtains a recipe. This step may be performed generally the same as or similar to step 205 of FIG. 2A. However, in this implementation, the recipe is associated with multiple cooking steps, not all of which are necessary to implement and complete the recipe.

Consider the following example involving a recipe for making a pasta dish. The recipe includes multiple cooking steps, including boiling water, cooking noodles, chopping ingredients, etc. Additionally, the recipe includes the following cooking steps that relate to the making of tomato paste:
A) weigh 1 pound of tomatoes
B) boil water
C) cook tomatoes in boiling water for 10 minutes
D) place tomatoes in ice
E) peel tomatoes
F) make tomato paste from peeled tomatoes

It should be noted that cooking step F or others of the above steps actually may be made up of multiple additional steps. Some people with limited experience in cooking or limited time may find the above cooking steps A-F overly complicated or burdensome. The recipe thus also may be associated with the following cooking step, which can substitute for the above cooking steps A-F:
G) obtain tomato paste from can

As discussed in connection with FIG. 4, in various embodiments, each of the above cooking steps is associated with a distinct cooking step data frame (e.g., data frame 400 of FIG. 4) and the cooking step data frames are all associated with a recipe (e.g., a recipe for making a pasta dish.) Each data frame 400 for a particular cooking step also includes or is associated with data indicating which other cooking step(s) the cooking step can substitute for. For instance, in the above example, the data frame for cooking step G (obtain tomato paste from can) is associated with or includes data indicating that step G can substitute for steps A-F. Additionally, in various embodiments, each of data frames for cooking steps A-F are associated with or include data indicating that cooking step G may substitute for cooking steps A-F.

In some implementations, a cooking step is optional. That is, the cooking step is not required for completing the recipe. For instance, in the above example, steps D and E are optional. The placement of the tomatoes in ice (step D) helps facilitate peeling. The peeling of the tomatoes (step E) may contribute to the making of a higher quality tomato paste. However, the tomato paste may also be made without steps D and E being performed. Accordingly, in various embodiments, a cooking step data frame for a particular optional cooking step includes or is associated with data indicating whether the associated cooking step is optional but not necessary.

At step 1110 of FIG. 11, the coordinating device 105 selects a subset of the cooking steps, which will later be used to carry out the recipe. This selection may be based on a wide variety of criteria and/or conditions. A simple example may be described as follows. In some embodiments, for example, a user has indicated (e.g., by providing input to the coordinating device 105) that he or she has limited time. Using the above example, under such circumstances the coordinating device 105 selects step G but not steps A-F, since the device 105 has determined that step G will be faster to perform then steps A-F.

Alternatively, the coordinating device 105 determines that the cooking proficiency of a particular user (e.g., step 215 of FIG. 2A) does not exceed a predefined level. To use the above example, the coordinating device thus selects step G but not steps A-F, since the device 105 has determined that step G is less complicated than steps A-F. In still another embodiment, the coordinating device 105 determines that the cooking proficiency of a particular user is quite high i.e., exceeds a predefined level. In that case, the device selects steps A-F and not step G, since the device 105 has determined that the user is capable of performing steps A-F and because steps A-F produce generally better results than step G.

Alternatively and/or additionally, the coordinating device 105 determines whether an optional step should be included in the implementation of the recipe or not. Using the above example, the device 105 may determine that a particular user needs to finish the pasta recipe quickly and/or is not particularly skillful at cooking (e.g., as determined in step 215 of FIG. 2A.) As a result, the device 105 selects steps A-C but not D and E, because D and E involve greater work, time and complexity. However, if the device 105 determines that the user has the requisite skill and/or sufficient time, then the device 105 may select steps A-C as well as steps D and E.

At step 1115, the coordinating device 105 determines a sequence of cooking steps. This step may be performed the same as or similar to step 235 of FIG. 2A. The determination of the sequence is based at least partly on the selection made in step 1110. That is, the sequence of cooking steps includes the selected subset of cooking steps. In various embodiments, unselected cooking steps are not included in the sequence. Afterward, at step 1120, the coordinating device 105 transmits the sequence to any suitable appliance(s). This step may be performed the same as or similar to step 240 of FIG. 2B.

Method 1100 and steps 1110, 1115 and 1120 may also be performed to adjust a sequence of cooking steps that are currently being implemented. For example, method 200 of FIGS. 2A and 2B describes an embodiment in which a sequence of cooking steps is implemented (e.g., step 245 of FIG. 2B.) The implementation is monitored (e.g., step 250.) During the implementation of the cooking steps, a particular condition may arise (e.g., step 260.) Based on this condition, the sequence of cooking steps is adjusted to generate a second, different sequence (e.g., step 265).

The generation of the second sequence may be based on the operations described above in connection with method 1100 of FIG. 11. That is, in some embodiments, the first sequence of cooking steps included a particular subset of cooking operations that were selected by the coordinating device (e.g., step 1110 of FIG. 11.) Based on and/or in response to the condition, the device 105 selects a different subset of cooking steps and determines the second sequence of cooking steps (e.g., as discussed in connection with step 1115), which includes the new subset.

An example of the above approach may be described as follows. Consider a situation in which a coordinating device 105 obtains the above recipe for making tomato pasta (e.g., step 205 of FIG. 2A.) The user has provided input to the device 105 indicating that he or she is moderately good at cooking, so the coordinating device 105 determines that his or her cooking proficiency is relatively high (e.g., step 215.) The device 105 selects a subset of the cooking steps for the recipe, which includes above steps A-F but not step G. This selection is based on the determination that the user has a relatively high level of cooking proficiency (e.g., step 1110 of FIG. 11.) The device 105 generates and transmits a sequence of cooking steps (e.g., steps 235 and 240 of FIGS. 2A and 2B and step 1115 of FIG. 11.) The sequence includes the selected subset i.e., steps A-F but not step G.

The cooking steps are implemented and monitored, as discussed in connection with steps 245 and 250 of FIG. 2B. However, the coordinating device 105 detects that the user is making mistakes in his or her performance of the steps—some steps are taking too long, some steps are done incorrectly, etc. (e.g., step 260 of FIG. 2B.) As a result, the coordinating device 105 determines that the cooking proficiency of the user is lower than initially estimated and updates his or her user profile accordingly (e.g., step 255 of FIG. 2B.) Based on the above conditions and the lowered estimated cooking proficiency of the user, the coordinating device selects a different subset of the cooking steps. That is, this subset includes the aforementioned step G and does not include steps A-F (e.g., step 1110 of FIG. 11.) The device 105 generates a new sequence that includes the new subset (e.g., step 1115 of FIG. 11 and step 265 of FIG. 2B.) That is, the new sequence includes steps A-F and not step G. The new sequence is then implemented and the user is guided through the associated cooking steps (e.g., as described in connection with steps 245-255 of FIG. 2B.)

Various operations described in this application are performed by the coordinating device 105/900 and/or an appliance 110a/110b/1000. It should be noted that each such operation can also be performed by another device in the cooking guidance system 100. In some embodiments, it is performed by a device that is coupled with a coordinating device and/or appliance using a network 130. By way of example, this application describes a coordinating device that is arranged to identify users, possibly by receiving input from them or requesting input from them (e.g., step 210 of FIG. 2A.) It is also possible that each user inputs his or her identity into another device such as a smart phone, a tablet, a computer and/or a wearable device. This device then transmits the inputted data and/or the identity of the user to the coordinating device.

Although only a few embodiments of the invention have been described in detail, it should be appreciated that the invention may be implemented in many other forms without departing from the spirit or scope of the invention. For example, the present application and figures describe various methods (e.g., method 200 of FIGS. 2A-2B and method 1100 of FIG. 11) that perform particular operations. It should be appreciated that in some embodiments, one or more of these operations/steps may be modified, reordered and/or deleted. Additionally, some figures, such as FIGS. 1 and 9-10, describe devices that contain various components. It should be noted that in some embodiments, one or more of these components may be merged together. In still other embodiments, one or more components may be separated into a greater number of components. The features of one component may be transferred to another and/or modified as appropriate. Each device may have additional components beyond what is shown in the corresponding figure. Particular modules or devices that are shown as being part of a particular object may instead be coupled with the object e.g., with a wired or wireless connection. In FIG. 10, for example, the functions of the user interface unit 1015 may be performed (at least in part) by a smart device (e.g., a smart phone, smart watch, etc.) that is wirelessly coupled with the appliance 1000. A user can thus provide any input described herein for the appliance 1000 using the smart device. The smart device then transmits the data to the appliance 1000 for processing as described herein. Therefore, the present embodiments should be considered illustrative and not restrictive and the invention is not to be limited to the details given herein.

What is claimed is:

1. A method for automatically guiding one or more users through steps of a recipe, the method comprising:
obtaining a recipe;
identifying one or more users that are involved in a cooking session using the recipe;
determining a cooking proficiency of each of the users;
determining a first sequence of cooking steps based on the recipe and the cooking proficiency of the one or more users; and
transmitting the first sequence to one or more appliances.

2. The method of claim 1 further comprising:
monitoring progress of an implementation of the first sequence of cooking steps at the one or more appliances.

3. The method of claim 2 further comprising:
during the monitoring operation, detecting a condition in the implementation of the first sequence of cooking steps; and
adjusting the first sequence of cooking steps to generate a second sequence of the cooking steps wherein the second sequence takes into account the detected condition.

4. The method of claim 3 wherein a difference between the first sequence of cooking steps and the second sequence of cooking steps involves one or more of: 1) an order of the cooking steps; 2) which steps are done in parallel; and 3) which user is performing each cooking step.

5. The method of claim 3 wherein the condition is one or more of 1) a problem in the implementation of one of the cooking steps; 2) a failure of a user to complete one of the cooking steps within an estimated time period; 3) an appearance of another user to help with the implementation of the first sequence of cooking steps; and 4) completion of one of the cooking steps in a shorter period of time than an estimated time period.

6. The method of claim 1 further comprising:
determining an estimated completion time for one or more of the cooking steps wherein the estimated completion time is based at least in part on the cooking proficiency.

7. The method of claim 1 wherein:
the first sequence of cooking steps indicates a plurality of steps used to carry out the recipe;
each of the plurality of steps is associated with an estimated completion time, an appliance instruction, a dependency indicator and an active/passive indicator wherein the dependency indicator indicates whether the step is required to follow another one of the steps and wherein the active/passive indicator indicates whether active user participation is required in order to complete the step; and
an order of cooking steps in the first sequence is based on the estimated completion time and the active/passive indicator.

8. The method of claim 1 wherein the determining of the cooking proficiency of each of the users further comprises:
identifying each of the users; and
obtaining data associated with each identified user that indicates one of: 1) time previously needed by the identified user to perform a cooking step; and 2) whether the identified user has previously performed one of the cooking steps correctly.

9. The method of claim 1 further comprising:
determining whether a user performed one of the cooking steps properly;
updating a cooking proficiency estimate for the user based on the cooking step performance determination; and
storing the cooking proficiency estimate at a coordinating device that is coupled with the one or more appliances.

10. A method comprising:
obtaining, at a device, a recipe including a plurality of cooking steps wherein not all of the plurality of cooking steps are necessary to implement the recipe;
selecting a first subset of the cooking steps that are sufficient to implement the recipe wherein one or more of the plurality of cooking steps are not selected;
determining a first sequence of the selected cooking steps; and
transmitting the first sequence of cooking steps to one or more appliances.

11. The method of claim 10 further comprising:
identifying one or more users that are involved in a cooking session using the recipe; and
determining a cooking proficiency of each of the users wherein the selection of the subset is based at least in part on the determined cooking proficiency.

12. The method of claim 10 further comprising:
monitoring progress of an implementation of the first sequence;
detecting a condition in the implementation of the first sequence of cooking steps; and
adjusting the first sequence of cooking steps to generate a second sequence of the cooking steps wherein the second sequence takes into account the detected condition.

13. The method of claim 12 further comprising:
selecting a second subset of the cooking steps based on the detected condition wherein:
the second subset of the cooking steps is different from the first subset; and
the second sequence includes the second subset of cooking steps.

14. The method of claim 12 wherein a difference between the first sequence of cooking steps and the second sequence of cooking steps involves one or more of: 1) an order of the cooking steps; 2) which steps are done in parallel; and 3) which user is performing each cooking step.

15. A computer readable storage medium including executable computer code embodied in a tangible form wherein the executable computer code is operable to perform the method of claim 10.

16. A device comprising:
at least one processor;
at least one memory including a computer readable storage medium that includes computer code stored in a tangible form wherein the computer code, when executed by the at least one processor, causes the device to:
obtain a recipe;
identify one or more users that are involved in a cooking session using the recipe;
determine a cooking proficiency of each of the users;
determine a first sequence of cooking steps based on the recipe and the cooking proficiency of the one or more users; and
transmit the first sequence to one or more appliances.

17. The device of claim 16 wherein the computer code, when executed by the at least one processor, further causes the device to:
monitor progress of an implementation of the first sequence of cooking steps at the one or more appliances.

18. The device of claim 17 wherein the computer code, when executed by the at least one processor, further causes the device to:
during the monitoring operation, detect a condition in the implementation of the first sequence of cooking steps; and
adjust the first sequence of cooking steps to generate a second sequence of the cooking steps wherein the second sequence takes into account the detected condition.

19. The device of claim 18 wherein a difference between the first sequence of cooking steps and the second sequence of cooking steps involves one or more of: 1) an order of the cooking steps; 2) which steps are done in parallel; and 3) which user is performing each cooking step.

20. The device of claim 18 wherein the condition is one or more of 1) a problem in the implementation of one of the cooking steps; 2) a failure of a user to complete one of the cooking steps within an estimated time period; 3) an appearance of another user to help with the implementation of the first sequence of cooking steps; and 4) completion of one of the cooking steps in a shorter period of time than an estimated time period.
